(19) United States
(12) Patent Application Publication
(10) Pub. No.: US 2012/0090795 A1
(43) Pub. Date: Apr. 19, 2012

(54) Manual Roller Shade System

(75) Inventor: David A. Kirby, Zionsville, PA (US)

(73) Assignee: LUTRON ELECTRONICS CO., INC., Coopersburg, PA (US)

(21) Appl. No.: 13/267,351

(22) Filed: Oct. 6, 2011

Related U.S. Application Data
(60) Provisional application No. 61/393,422, filed on Oct. 15, 2010.

(51) Int. Cl. E06B 9/68; E06B 9/44

(52) U.S. Cl. 160/307; 160/321

(57) ABSTRACT

A manual roller shade system includes a rotatably-mounted roller tube, a flexible shade fabric windingly received around the roller tube, and first and second elongated telescoping structures that allow for rotating the roller tube for manually raising and lowering the shade fabric. The roller shade system also has a clutch mechanism coupled to the roller tube, and a drive chain coupled to the clutch mechanism. The first and second elongated telescoping structures receive first and second end portions of the drive chain, respectively, and are connected to the first and second telescoping structures, such that the roller tube rotates in the first angular direction to raise the shade fabric when the first telescoping structure is pulled downward, and in the second angular direction to lower the shade fabric when the second telescoping structure is pulled downward.

### CROSS-REFERENCE TO RELATED APPLICATIONS

This application is a non-provisional application of commonly-assigned U.S. Provisional Application No. 61/393,422, filed Oct. 15, 2010, entitled MANUAL ROLLER SHADE SYSTEM, the entire disclosure of which is hereby incorporated by reference.

### BACKGROUND OF THE INVENTION

1. Field of the Invention

The present invention relates to a window treatment, and more particularly, to a manually-controlled roller shade system having elongated telescoping structures adapted to be manipulated by a user to raise and lower a shade fabric of the roller shade system.

2. Description of the Related Art

Typical window treatments, such as, for example, roller shades, draperies, roman shades, and venetian blinds, are mounted in front of windows or openings to prevent sunlight from entering a space and to provide privacy. A roller shade includes a flexible shade fabric wound onto an elongated roller tube for raising and lowering the shade fabric by rotating the roller tube. In a manual roller shade system, the rotation of the roller tube is provided by an input wheel that receives an input chain for converting a pulling force applied to the input chain into rotation of the input wheel. Manual roller shades typically include clutches having gear assemblies for transmitting the rotation of the input wheel to the rotation of the roller tube.

### SUMMARY OF THE INVENTION

According to an embodiment of the present invention, a roller shade system comprises a rotatably-mounted roller tube, a flexible shade fabric windingly received around the roller tube, an elongated drive cord, and first and second elongated telescoping structures that allow for rotating the roller tube for manually raising and lowering the shade fabric. The shade fabric has a first fabric end connected to the roller tube and a second fabric end opposite the first fabric end, while the drive cord has first and second opposite ends. The roller tube is operable to rotate in a first angular direction to lower the shade fabric when the first end of the drive cord is pulled in a downward vertical direction, and in a second angular direction opposite the first angular direction to raise the shade fabric when the second end of the drive cord is pulled in the downward vertical direction. The first and second elongated telescoping structures receive the first and second ends of the drive cord, respectively. The first and second ends of the drive cord are connected to the first and second telescoping structures, respectively, such that the roller tube rotates in the first angular direction when the first telescoping structure is pulled in the downward vertical direction, and in the second angular direction when the second telescoping structure is pulled in the downward vertical direction.

The roller shade system may further comprise first and second opposite mounting brackets, and a clutch mechanism having a first end connected to the first mounting bracket, and a second end connected to the roller tube, such that the second end is adapted to rotate with respect to the first end to allow for rotation of the roller tube. The roller tube may be rotatably mounted between the mounting brackets. The drive cord may comprise a drive chain coupled to the second end of the clutch mechanism and having first and second chain portions that hang from the clutch mechanism and are received in the respective telescoping structures.

Other features and advantages of the present invention will become apparent from the following description of the invention that refers to the accompanying drawings.

### BRIEF DESCRIPTION OF THE DRAWINGS

The invention will now be described in greater detail in the following detailed description with reference to the drawings in which:

FIG. 1 is a perspective view of a manual roller shade system having telescoping structures for raising and lowering a shade fabric according to an embodiment of the present invention;

FIG. 2 is a front view of the manual roller shade system of FIG. 1;

FIG. 3 is a right side cross-sectional view of the roller shade system of FIG. 1 taken through the center of the telescoping structures;

FIG. 4 is an enlarged portion of the right-side cross-sectional view of the roller shade system shown in FIG. 3; and

FIG. 5 is an exploded perspective view of a clutch mechanism of the roller shade system of FIG. 1.

### DETAILED DESCRIPTION OF THE INVENTION

The foregoing summary, as well as the following detailed description of the embodiments of the present invention, is better understood when read in conjunction with the appended drawings. For the purposes of illustrating the invention, there is shown in the drawings an embodiment that is presently preferred, in which like numerals represent similar parts throughout the several views of the drawings, it being understood, however, that the invention is not limited to the specific methods and instrumentalities disclosed.

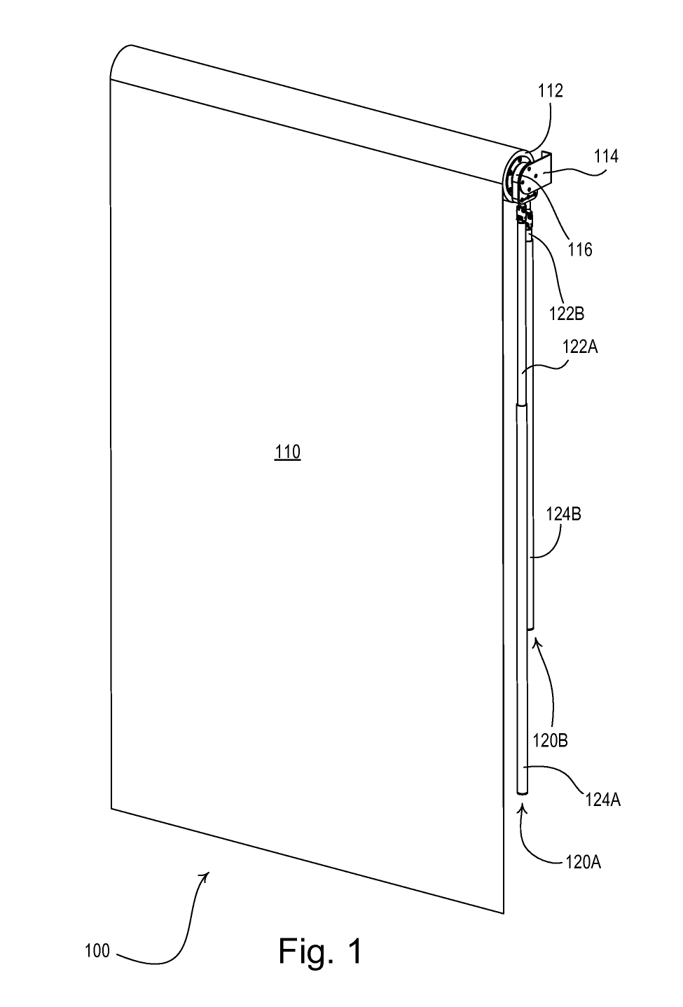

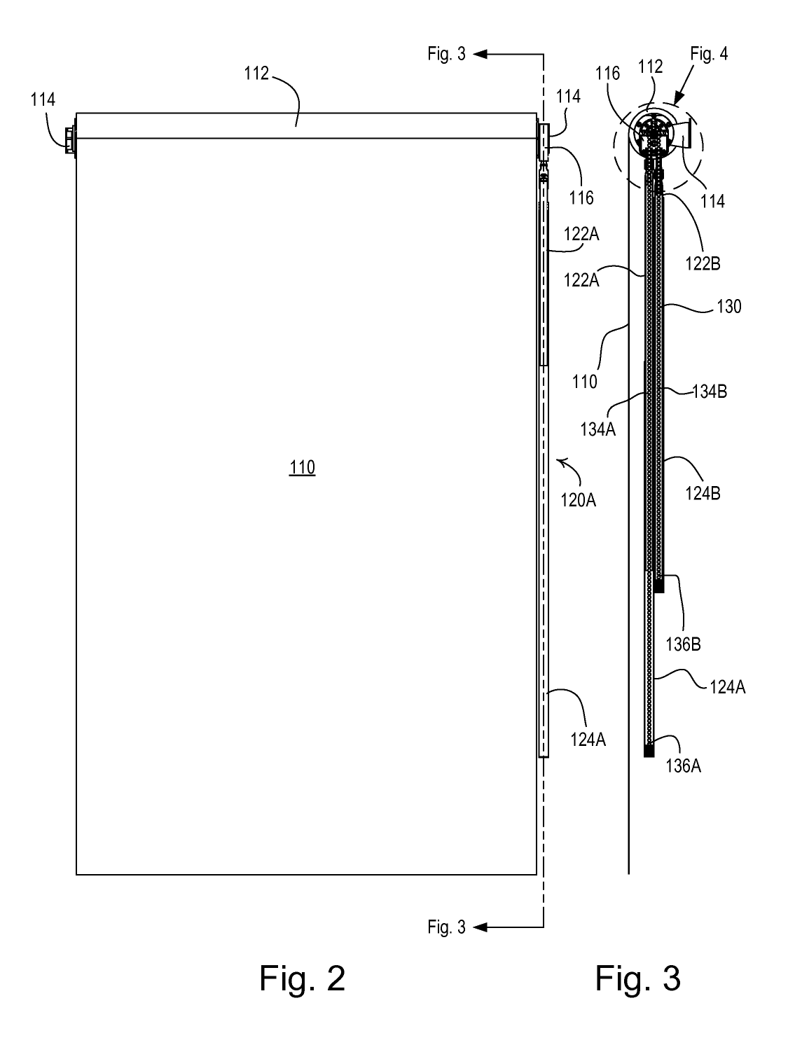

FIG. 1 is a perspective view and FIG. 2 is a front view of a manual roller shade system 100 according to an embodiment of the present invention. The roller shade system 100 comprises a shade fabric 110 that is windingly received around a roller tube 112. The shade fabric 110 has a first fabric end connected to the roller tube 112 and a second fabric end opposite the first fabric end. The roller tube 112 has two opposite tube ends and is rotatably coupled at the tube ends to two opposite mounting brackets 114, which are connected to a vertical surface, e.g., a wall. The roller shade system 100 further comprises a manual clutch mechanism 116 coupled between one end of the roller tube 112 and one of the mounting brackets 114 to provide for manual rotation of the roller tube to thus raise and lower the shade fabric 110 between a fully-open position and a fully-closed position. An example of a manual clutch mechanism is described in greater detail in commonly-assigned U.S. patent application Ser. No. 12/769,069, filed Apr. 28, 2010, entitled MANUAL ROLLER SHADE HAVING CLUTCH MECHANISM, CHAIN GUIDE AND UNIVERSAL MOUNTING, the entire disclosure of which is hereby incorporated by reference.

The roller shade system 100 further comprises first and second elongated telescoping structures 120A, 120B that are coupled to the manual clutch mechanism 116 and allow a user to manually raise and lower the shade fabric 110 as will be described in greater detail below. Each of the telescoping structures 120A, 120B comprises an inner tube 122A, 122B and an outer tube 124A, 124B, respectively. Each inner tube 122A, 122B is coupled to the clutch mechanism 116 and is slidingly received in the respective outer tube 124A, 124B. The user is able to grasp the first outer tube 124A and pull downward to move the first outer tube with respect to the first inner tube to thus lower the shade fabric 112. In addition, the user is able to pull the second outer tube 124B downward to raise the second fabric end of the shade fabric 112.

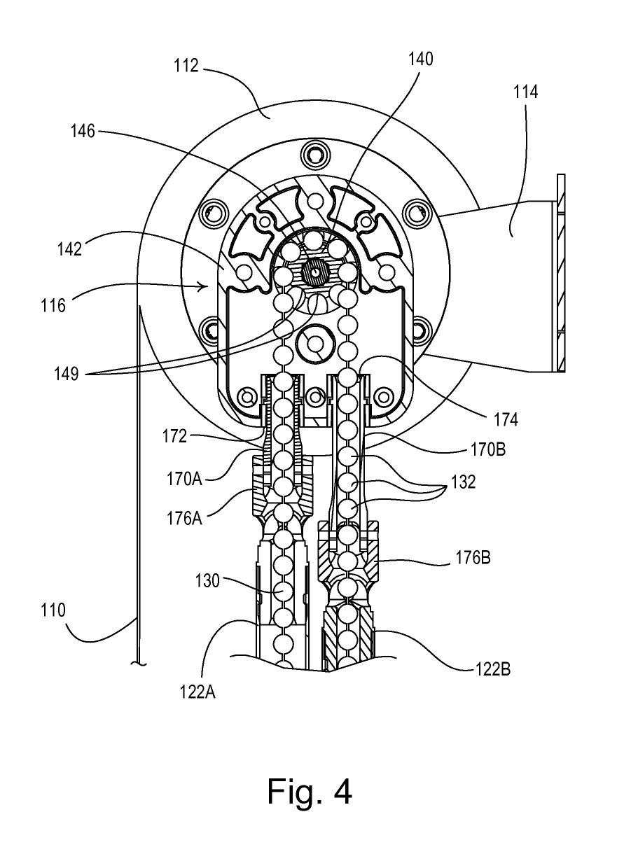

FIG. 3 is a right side cross-sectional view of the roller shade system 100 taken through the center of the telescoping structures 120A, 120B as shown in FIG. 2. FIG. 4 is an enlarged portion of the right-side cross-sectional view of the roller shade system 100 shown in FIG. 3. The roller shade system 100 comprises an elongated drive chain 130 having, for example, spherical beads 132 spaced along the length of the drive chain. As shown in FIG. 3, the drive chain 130 is received by the clutch mechanism 116, such that opposite portions 134A, 134B of the drive chain hang from the clutch mechanism. The first and second portions 134A, 134B of the drive chain 130 are received in the first and second telescoping structures 120A, 120B, respectively. The drive chain 130 further comprises first and second opposite ends 136A, 136B that are connected to the respective outer tubes 124A, 124B of the telescoping structures 120A, 120B. Alternatively, the locations of the inner tubes 122A, 122B and the outer tubes 124A, 124B could be switched, such that outer tubes could be coupled to the clutch mechanism 116, while the first and second opposite ends 136A, 136B of the drive chain 130 could be coupled to the inner tubes.

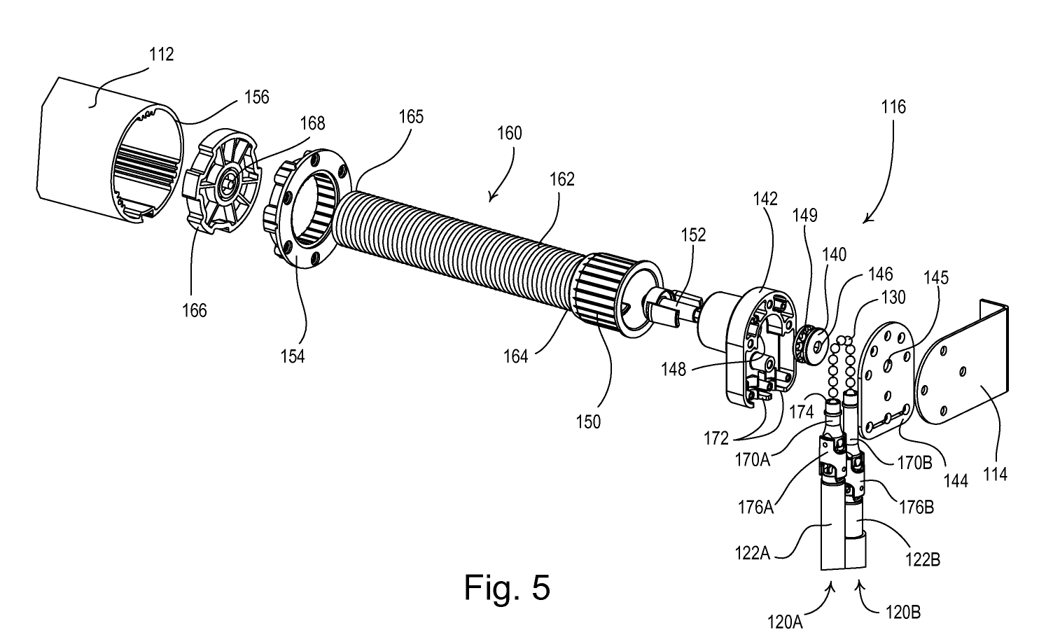

FIG. 5 is an exploded perspective view of the clutch mechanism 116 of the roller shade system 100. The clutch mechanism 116 comprises a drive chain sprocket 140, which is rotatably mounted in a clutch mechanism enclosure 142 when a clutch mechanism plate 144 is attached to the clutch mechanism enclosure. While not shown in FIG. 5, an elongated shaft is connected to the nearest mounting bracket 114 and extends through an opening 145 in the clutch mechanism plate 144, an opening 146 in the drive chain sprocket 140, and an opening 148 in the clutch mechanism enclosure 142. The drive chain sprocket 140 includes rounded notches 149 spaced about the sprocket for receiving the beads 132 of the drive chain 130, which facilitates transfer of a pulling force applied to the drive chain to the drive chain sprocket for thus rotating the roller tube 112. The clutch mechanism 116 is adapted for bi-directional operation, such that the roller tube 114 is operable to rotate in a first angular direction to lower the shade fabric 110 when the first outer tube 124A is pulled in a downward vertical direction, and in a second angular direction opposite the first angular direction to raise the shade fabric 112 when the second outer tube 124B is pulled in the downward vertical direction. Alternatively, the drive chain 130 could comprise an elongated drive cord that could be coupled to the roller tube 112, for example, via frictional force.

The drive chain sprocket 140 is coupled to a cylindrical drive output 150 via a brake spring carrier 152, such that rotation of the sprocket results in rotation of the drive output. The brake spring carrier 152 is adapted to hold a brake spring (not shown) to operate as a standard spring-wrap brake (as described in greater detail in the previously-referenced U.S. patent application Ser. No. 12/769,069). The cylindrical drive output 150 is adapted to be received through and rigidly attached to a tube adapter 154, which is adapted to be connected to an opening 156 at the adjacent end of the roller tube 112.

The roller shade system 100 further comprises a spring-assist assembly 160, which is located inside the roller tube 112. The spring-assist assembly 160 comprises a spring 162 having a first end 164 attached to the drive output 150, and a second opposite end 165 fixedly connected to the elongated shaft (not shown) that is connected to the nearest mounting bracket 114 and extends through the openings 145, 146, 148 of the clutch mechanism 116. A support puck 166 is located inside the roller tube 112 and comprises a pin 168 at the center. The second end 165 of the spring 162 of the spring-assist assembly 160 is rotatably attached to pin 168 of the puck 166 to horizontally support the spring. As the roller tube 112 is rotated in the first angular direction to lower the shade fabric 110, the first end 164 of the spring rotates while the second end 165 of the spring 162 is held in place by the elongated shaft. Accordingly, the spring 162 builds up tension and exerts a force on the roller tube 112 in the second angular direction, which counteracts the force on the roller tube due to the weight of the shade fabric 110 and provides assistance to the user when raising the shade fabric (i.e., reduces the pulling force required by the user).

The first and second telescoping structures 120A, 120B are coupled to the clutch mechanism via respective intermediate tubes 170A, 170B. Specifically, the intermediate tubes 170A, 170B are received through attachment notches 172 of the clutch mechanism enclosure 142, and are held in place when the clutch mechanism plate 144 is attached to the clutch mechanism enclosure. The drive chain 130 loops around the drive chain sprocket 140, and the first and second portions 134A, 134B of the drive chain are received through respective openings 174 of the intermediate tubes 170A, 170B. The intermediate tubes 170A, 170B are coupled to the respective inner tubes 122A, 122B via respective pivoting structures 176A, 176B. The pivoting structures 176A, 176B allow the respective telescoping structures 170A, 170B to pivot about two different axes that are 90 degrees apart from each other as shown in FIG. 5. In addition, the intermediate tubes 170A, 170B are operable to rotate in the attachment notches 172 of the clutch mechanism enclosure 142 to allow for rotation of the respective telescoping portion 120A, 120B.

The length of the outer tube 124A, 124B of each telescoping structure 120A, 120B limits the vertical distance across which the ends 136A, 136B of the drive chain 130 may be moved. Accordingly, the roller tube 112 and the clutch mechanism 116 are designed such that a movement of the drive chain 130 across a first distance d₁ results in a movement of the second end of the shade fabric 110 across a second distance d₂ greater than the first distance d₁. The linear velocity v₁ of the drive chain 130 (and thus the first distance d₁) is dependent upon the radius r₁ of the drive chain sprocket 140 (at which the drive chain meets the notches 149 of the sprocket) and the angular velocity ω of the sprocket (i.e., v₁=ω·r₁). Similarly, the linear velocity v₂ of the shade fabric 110 (and thus the second distance d₂) is a function of the radius r₂ of the roller tube 112 and the angular velocity ω of the sprocket (i.e., v₂=ω·r₂). Accordingly, the second distance d₂ across which the second end of the shade fabric 110 moves is a function of the first distance d₁ across which either of the outer tubes 124A, 124B is moved, as well as the radii r₁, r₂ of the drive chain sprocket 140 and the roller tube 112, i.e., d₂=(r₂/r₁)·d₁. For example, the inner tubes 122a, 122B and the outer tubes 124A, 124B could be sized to have lengths equal to approximately one-third of the length of the fully-unwound shade fabric 110, such that the outer tubes 124A, 124B may be moved across a distance of approximately one-third of the length of the shade fabric to move the second end of the shade fabric between the fully-open position and the fully-closed position (i.e., the ratio r₂/r₁ between the radii r₁, r₂ of the drive chain sprocket 140 and the roller tube 112 is approximately three).

Thus, while the roller shade system 100 does not comprise a gear assembly, the roller tube 112 and the clutch mechanism 116 are simply sized to achieve the appropriate relationship between the first distance d₁ across which either of the outer tubes 124A, 124B is moved and the second distance d₂ across which the second end of the shade fabric 110 moves, such that small movements of the outer tubes of the telescoping structures 120A, 120B result in larger movements of the shade fabric. Alternatively, the roller shade system 100 could comprise a gear assembly to result in a different relationship between the first and second distances d₁, d₂.

While the present invention has been described with reference to the roller shade system 100, the telescoping structures 120A, 120B of the present invention could be used on other types of window treatments, such as, for example, draperies, Roman shades, Venetian blinds, tensioned roller shade systems, and roller shade systems having pleated shade fabrics. An example of a drapery system is described in greater detail in commonly-assigned U.S. Pat. No. 6,994,145, issued Feb. 7, 2006, entitled MOTORIZED DRAPERY PULL SYSTEM, the entire disclosure of which is hereby incorporated by reference. An example of a Roman shade system is described in greater detail in commonly-assigned U.S. patent application Ser. No. 12/784,096, filed Mar. 20, 2010, entitled ROMAN SHADE SYSTEM, the entire disclosure of which is hereby incorporated by reference. An example of a Venetian blind system is described in greater detail in commonly-assigned U.S. Provisional Patent Application No. 61/384,005, filed Sep. 17, 2010, entitled MOTORIZED VENETIAN BLIND SYSTEM, the entire disclosure of which is hereby incorporated by reference. An example of a tensioned roller shade system is described in greater detail in commonly-assigned U.S. patent application Ser. No. 12/061,802, filed Apr. 3, 2008, entitled SELF-CONTAINED TENSIONED ROLLER SHADE SYSTEM, the entire disclosure of which is hereby incorporated by reference. An example of a roller shade system having a pleated shade fabric is described in greater detail in commonly-assigned U.S. patent application Ser. No. 12/430,458, filed Apr. 27, 2009, entitled ROLLER SHADE SYSTEM HAVING A HEMBAR FOR PLEATING A SHADE FABRIC, the entire disclosure of which is hereby incorporated by reference.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A roller shade system comprising:
a rotatably-mounted roller tube;
a flexible shade fabric windingly received around the roller tube, the shade fabric having a first fabric end connected to the roller tube and a second fabric end opposite the first fabric end;
an elongated drive cord having first and second opposite ends, the roller tube operable to rotate in a first angular direction to lower the shade fabric when the first end of the drive cord is pulled in a downward vertical direction, and in a second angular direction opposite the first angular direction to raise the shade fabric when the second end of the drive cord is pulled in the downward vertical direction;
first and second elongated telescoping structures receiving the first and second ends of the drive cord, respectively;
wherein the first and second ends of the drive cord are connected to the first and second telescoping structures, respectively, such that the roller tube rotates in the first angular direction when the first telescoping structure is pulled in the downward vertical direction, and in the second angular direction when the second telescoping structure is pulled in the downward vertical direction.

2. The roller shade system of claim 1, further comprising:
first and second opposite mounting brackets, the roller tube rotatably mounted between the mounting brackets; and
a clutch mechanism having a first end connected to the first mounting bracket, and a second end connected to the roller tube, the second end adapted to rotate with respect to the first end to allow for rotation of the roller tube;
wherein the drive cord comprises a drive chain coupled to the second end of the clutch mechanism, the drive chain having first and second chain portions hanging from the clutch mechanism and received in the respective telescoping structures.

3. The roller shade system of claim 2, wherein a movement of the drive chain across a first distance results in a movement of the second end of the shade fabric across a second distance greater than the first distance.

4. The roller shade system of claim 3, wherein the drive chain comprises a chain having spherical beads spaced along the length of the drive chain, the clutch mechanism comprising a sprocket coupled to the second end of the clutch mechanism and having rounded notches spaced about the sprocket for receiving the beads of the drive chain.

5. The roller shade system of claim 4, wherein a relationship between the first and second distances is dependent upon the radii of the roller tube and the sprocket of the clutch mechanism.

6. The roller shade system of claim 5, wherein the first distance is approximately one-third of the second distance.

7. The roller shade system of claim 2, wherein each of the first and second telescoping structures is pivotably connected to the clutch mechanism.

8. The roller shade system of claim 7, wherein each of the first and second telescoping structures is able to pivot about two different axes.

9. The roller shade system of claim 8, wherein the two different axes about which the each of the first and second telescoping structures is able to pivot are 90 degrees apart.

10. The roller shade system of claim 7, wherein each of the first and second telescoping structures is further rotatably connected to the clutch mechanism.

11. The roller shade system of claim 2, wherein each of the first and second telescoping structures comprises an inner tube slidingly received in an outer tube.

12. The roller shade system of claim 11, wherein the inner tube of each telescoping structure is coupled to the clutch mechanism, and the first and second ends of the drive chain are connected to the outer tubes of the respective telescoping structures.

13. The roller shade system of claim 11, wherein the outer tube of each telescoping structure is coupled to the clutch mechanism, and the first and second ends of the drive chain are connected to the inner tubes of the respective telescoping structures.

14. The roller shade system of claim 2, further comprising:
a spring assist assembly located inside the roller tube for providing a force in the second angular direction to provide assistance when the shade fabric is being raised.

15. The roller shade system of claim 14, wherein the spring assist assembly is located in the end of the roller tube to which the clutch mechanism is connected.

16. A roller shade system comprising:
first and second opposite mounting brackets;
a roller tube rotatably mounted between the mounting brackets;
a flexible shade fabric windingly received around the roller tube, the shade fabric having a first fabric end connected to the roller tube and a second fabric end opposite the first fabric end;
a clutch mechanism having a first end connected to the first mounting bracket, and a second end connected to the roller tube, the second end adapted to rotate with respect to the first end to allow for rotation of the roller tube;
an elongated drive chain coupled to the second end of the clutch mechanism, the drive chain having first and second opposite ends, and respective first and second chain portions hanging from the second end of the clutch mechanism, the roller tube operable to rotate in a first angular direction to lower the shade fabric when the first end portion of the drive chain is pulled in a downward vertical direction, and in a second angular direction opposite the first angular direction to raise the shade fabric when the second end portion of the drive chain is pulled in the downward vertical direction;
wherein the improvement comprises first and second elongated telescoping structures receiving the first and second end portions of the drive chain, respectively, the first and second ends of the drive chain connected to the first and second telescoping structures, such that the roller tube rotates in the first angular direction when the first telescoping structure is pulled in the downward vertical direction, and in the second angular direction when the second telescoping structure is pulled in the downward vertical direction.

17. The roller shade system of claim 16, wherein each of the first and second telescoping structures comprises an inner tube slidingly received in an outer tube.

18. The roller shade system of claim 17, wherein the drive chain comprises a chain having spherical beads spaced along the length of the drive chain, the clutch mechanism comprising a sprocket coupled to the second end of the clutch mechanism and having rounded notches spaced about the sprocket for receiving the beads of the drive chain.

19. The roller shade system of claim 18, wherein a movement of the drive chain across a first distance results in a movement of the second end of the shade fabric across a second distance greater than the first distance, and a relationship between the first and second distances is dependent upon the radii of the roller tube and the sprocket of the clutch mechanism.

20. The roller shade system of claim 19, wherein the first distance is approximately one-third of the second distance.
